(19) United States
(12) Patent Application Publication
(10) Pub. No.: US 2011/0210704 A1
(43) Pub. Date: Sep. 1, 2011

(54) MULTIPLE BAY BATTERY CHARGERS AND CIRCUITRY

(76) Inventor: William Baker, Indianapolis, IN (US)

(21) Appl. No.: 12/896,329

(22) Filed: Oct. 1, 2010

Related U.S. Application Data
(63) Continuation of application No. PCT/US2009/039108, filed on Apr. 1, 2009.
(60) Provisional application No. 61/041,411, filed on Apr. 1, 2008.

(51) Int. Cl. H02J 7/10

(52) U.S. Cl. 320/164

(57) ABSTRACT

A multi-bay battery charger comprises a power supply (10), a flyback converter (30) including a transformer (40) defining a primary circuit (50) and a secondary circuit (60), a primary circuit controller (70) and a secondary circuit controller (80). The primary circuit (50) includes a primary control switch (51) having a closed state for electrically connecting the transformer (40) to the power supply (10). The primary circuit controller (70) applies a voltage pulse to the primary control switch (51) for selectively closing the primary control switch (51). The secondary circuit controller (80) applies a regulation voltage to the primary circuit controller (70) for modulating a duty cycle of the voltage pulses as a function of a sensed battery voltage relative to a maximum voltage threshold of a rechargeable battery (20) connected to the secondary circuit and of a sensed battery current relative to a maximum current threshold of the rechargeable battery (20).

CROSS-REFERENCE TO PRIOR APPLICATION

This application is a continuation of International Application No. PCT/US2009/039108, filed Apr. 1, 2009, which claims the benefit of U.S. patent application Ser. No. 61/041,411 filed Apr. 1, 2007, both of which are hereby incorporated by reference in their entirety.

### FIELD OF THE INVENTION

The present invention generally relates to battery chargers and circuits. The present invention specifically relates to multiple bay battery chargers and circuits for a multiple of battery types.

### BACKGROUND OF THE INVENTION

Battery chargers are devices that may be plugged into an ac outlet to deliver a dc voltage to a rechargeable battery. Battery chargers typically have been custom designed from a generic design for a specific rechargeable battery. The industry however is in need of an injection molded pocket that will service a multitude of battery types that share a set of physical features (the footprint).

Additionally, the use of flyback converters in a battery charger has been premised on control modes exclusively based on the battery voltage of the converter. While proven satisfactory for standard battery chargers, these control modes are not cost or energy effective for multi-bay battery chargers, which provide convenience and cost-effectiveness for organizations that require re-charging of a large number of electronic batteries for laptop computers. Such applications include academic organizations like high schools and colleges, and company's that rely on the continual use of laptop computers.

### SUMMARY OF THE INVENTION

The present invention provides a new and unique multiple bay battery chargers and circuits for a multiple of battery types.

In a first form of the present invention, a multi-bay battery charger comprises a power supply and a flyback converter including a transformer defining a primary circuit and a secondary circuit. The primary circuit includes a primary control switch having a closed state for electrically connecting the transformer to the power supply, and an open state for electrically disconnecting the transformer from the power supply. The secondary circuit may be electrically connected to one or more rechargeable batteries for supplying a battery voltage and a battery current to each rechargeable battery.

The multi-bay battery charger further comprises a primary circuit controller and a secondary circuit controller. The primary circuit controller applies a voltage pulse to the primary control switch for selectively closing primary control switch. The secondary circuit controller electrically senses the battery voltage and the battery current being supplied by the secondary circuit to each rechargeable battery connected to the secondary circuit. The secondary circuit controller further applies regulation voltage to the primary circuit controller for modulating a duty cycle of the voltage pulses provided by the primary circuit controller to the primary control switch, and modulates an amplitude of the regulation voltage as a function of the sensed battery voltage of each rechargeable battery relative to a maximum voltage threshold of each rechargeable battery and as a function of the sensed battery current of each rechargeable battery relative to a maximum current threshold of each rechargeable battery.

The foregoing form and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a first exemplary block diagram of a recharging circuit in accordance with the present invention;

FIG. 2 illustrates an exemplary graphical representation of a ration of a duty cycle of a pulse width modulated voltage to a pulse frequency of a voltage pulse in accordance with the present invention;

FIG. 3 illustrates a first exemplary graphical representation of a battery voltage during a battery current escalation phase and a battery current attenuation phase in accordance with the present invention;

FIG. 4 illustrates a first exemplary graphical representation of a battery current during a battery current escalation phase and a battery current attenuation phase in accordance with the present invention;

FIG. 5 illustrates a first exemplary schematic diagram of the recharging circuit illustrated in FIG. 1 in accordance with the present invention;

FIG. 6 illustrates a second exemplary block diagram of a recharging circuit in accordance with the present invention;

FIG. 7 illustrates a second exemplary graphical representation of a battery voltage during a battery current escalation phase and a battery current attenuation phase in accordance with the present invention;

FIG. 8 illustrates a second exemplary graphical representation of a battery current during a battery current escalation phase and a battery current attenuation phase in accordance with the present invention;

FIG. 9 illustrates a third exemplary graphical representation of a battery voltage during a battery current escalation phase and a battery current attenuation phase in accordance with the present invention;

FIG. 10 illustrates a third exemplary graphical representation of a battery current during a battery current escalation phase and a battery current attenuation phase in accordance with the present invention;

FIG. 11 illustrates a first exemplary schematic diagram of the recharging circuit illustrated in FIG. 5 in accordance with the present invention;

FIG. 12 illustrate a first exemplary 16-bay embodiment of a battery charger in accordance with the present invention;

FIGS. 13 AND 14 ILLUSTRATE EXEMPLARY EMBODIMENTS OF AN INJECTION MOLDED POCKET THAT WILL SERVICE A MULTITUDE OF BATTERY TYPES THAT SHARE A SET OF PHYSICAL FEATURES (THE FOOTPRINT) IN ACCORDANCE WITH THE PRESENT INVENTION;

FIG. 15 illustrates a second exemplary schematic diagram of the recharging circuit illustrated in FIG. 1 in accordance with the present invention;

FIG. 16 illustrate a second exemplary 8-bay embodiment of a battery charger in accordance with the present invention; and

FIG. 17 illustrates a second exemplary schematic diagram of the recharging circuit illustrated in FIG. 5 in accordance with the present invention.

### DETAILED DESCRIPTION OF THE PRESENT INVENTION

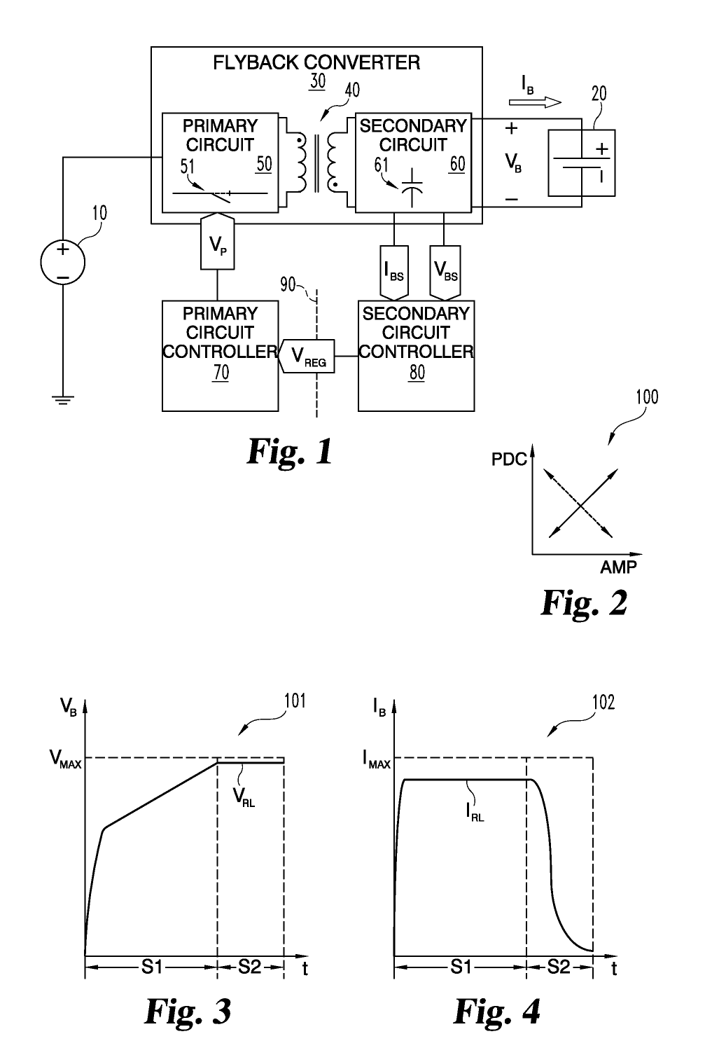

FIG. 1 illustrates a recharging circuit of the present invention for a single rechargeable battery 20 of any type. Generally, a flyback converter 30 employs a transformer 40 defining a primary circuit 50 and a secondary circuit 60. An operating state of primary control switch 51 of the primary circuit 50 controls a recharging of rechargeable battery 20. Specifically, a closed state of power control switch 51, as indicated by the dashed line in FIG. 1, electrically connects a power supply 10 of any type to transformer 40 whereby power supply 10 charges transformer 40 while a capacitor 61 of secondary circuit 60 discharges power stored therein to rechargeable battery 20 in the form of a battery voltage V_{B} and a battery current I_{B}. Conversely, an open state of power control switch 51, as indicated by the solid line shown in FIG. 1, electrically disconnects power supply 10 from transformer 40 whereby transformer 40 discharges power stored therein to rechargeable battery 20 in the form of battery voltage V_{B} and battery current I_{B} and also charges capacitor 61 of secondary circuit 60.

Primary circuit controller 70 applies a voltage pulse V_{P} to power control switch 51 for selectively closing power control switch 51. A pulse duty cycle PDC of voltage pulse V_{P} is modulated by a regulation voltage V_{REG} applied to primary circuit controller 70 by a secondary circuit controller 80 via an electric isolation barrier 90. In one embodiment, the pulse duty cycle PDC of voltage pulse V_{P} may increase as an amplitude of regulation voltage V_{REG} increases as shown by the solid line in FIG. 2. Conversely, the pulse duty cycle PDC of voltage pulse V_{P} may decrease as an amplitude of regulation voltage V_{REG} increases as shown by the dashed line in FIG. 2.

More importantly, the operating principle of secondary circuit controller 80 inputs a sensed battery voltage V_{BS} and a sensed battery current I_{BS} for purposes of modulating the amplitude AMP of regulation voltage V_{REG} in view of a maximum voltage threshold V_{MAX} of rechargeable battery 20 as shown FIG. 3 and in view of a maximum current threshold I_{MAX} of rechargeable battery 20 as shown in FIG. 4. To this end, upon an electrical connection of rechargeable battery 20 to secondary circuit 60, secondary circuit controller 80 initiates a recharging stage S1 whereby secondary circuit controller 80 modulates the amplitude AMP of regulation voltage V_{REG} as needed to increase the transformer voltage (not shown) above battery voltage V_{B} to a degree for immediately increasing battery current I_{B} to a recharging current level _{IRL} below maximum current threshold I_{MAX} as shown in FIG. 4. As a result, battery voltage V_{B} will increase as shown in FIG. 3 and secondary circuit controller 80 will continue to modulate the amplitude AMP of regulation voltage V_{REG} as needed until battery voltage V_{B} reaches a voltage recharge level V_{RL} below maximum voltage threshold V_{MAX}. Upon battery voltage V_{B} reaching voltage recharge level V_{RL}, secondary circuit controller 80 initiates a leveling stage S2 whereby secondary circuit controller 80 modulates the amplitude AMP of regulation voltage V_{REG} as needed to decrease the transformer voltage in a direction toward the battery voltage V_{B} for attenuating battery current I_{B} until the completion of stage S2 as shown in FIG. 4.

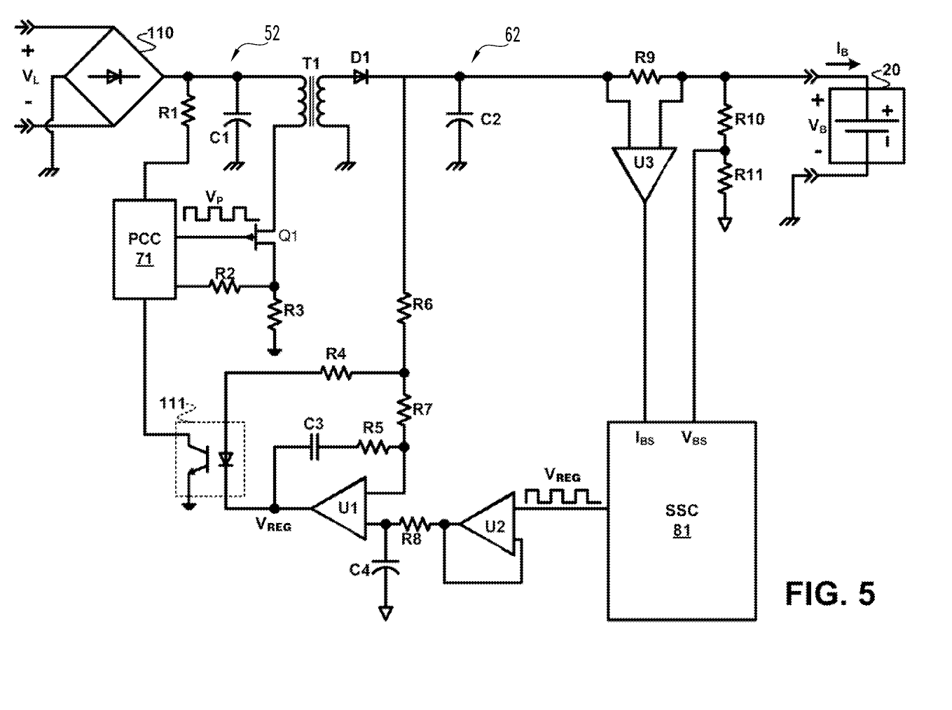

FIG. 5 illustrates a more detailed embodiment of the recharging circuit of FIG. 1. A primary circuit 52 includes a diode bridge 110, a capacitor C1, a MOSFET Q1 (i.e., a power control switch) and a resistor R3 connected to a primary side of a transformer T1 as shown. A primary circuit controller 71 includes a resistor R1 and a resistor R2 connected to primary circuit 52 as shown. In operation, diode bridge 110 applies a line voltage V_{L} from a power supply to transformer T1 in dependence of an operating state of MOSFET Q1. Specifically, a closed state of MOSFET Q1 electrically connects transformer T1 to the power supply whereby current flows from the power supply through the primary side of transformer T1 and MOSFET Q1 to ground, and an open state of MOSFET Q1 electrically disconnects transformer T1 from the power supply. Primary circuit controller 71 senses any current flow through MOSFET Q1 to determine a voltage across MOSFET Q1 and modulates a duty cycle of voltage pulse V_{P} as a function of a comparison of the voltage across MOSFET Q1 to regulation voltage V_{REG}. In one embodiment, primary circuit controller 71 increases the duty cycle of voltage pulse V_{P} in response to regulation voltage V_{REG} being greater than voltage across MOSFET Q1, and conversely decreases the duty cycle of voltage pulse V_{P} in response to regulation voltage V_{REG} being less than the voltage across MOSFET Q1.

Still referring to FIG. 5, a secondary circuit 62 includes a diode D1 and a capacitor C3 connected to a secondary side of transformer T1 as shown. A secondary circuit controller 81 includes resistors R4-R11, capacitors C3 and C4, op-amps U1 and U2, and a op-amp U3. In operation, the secondary side of transformer T1 discharges power stored therein across resistor R9 to rechargeable load 20 in response to an opening of MOSFET Q1 and conversely, capacitor C2 discharges power stored therein across resistor R9 in response to a closing of MOSFET Q1. Op-amp U3 applies a differential between the transformer voltage and battery voltage V_{B} across resistor R9 to enable secondary circuit controller 81 to sense battery current I_{B}. Resistors R10 and R11 operates as a voltage divider to enable secondary circuit controller 81 to sense battery voltage V_{B}.

Upon an electrical connection of rechargeable battery 20 to secondary circuit 62, secondary circuit controller 81 initiates a recharging stage S1 whereby secondary circuit controller 81 modulates the amplitude AMP of regulation voltage V_{REG} as needed to increase the transformer voltage (not shown) above battery voltage V_{B} to a degree for immediately increasing battery current I_{B} to a recharging current level _{IRL} below maximum current threshold I_{MAX} as shown in FIG. 4. In particular, secondary circuit controller 81 outputs a digital version of regulation voltage V_{REG} that is converted into an analog version of regulation voltage V_{REG} at an output of device U1 whereby the analog version of regulation V_{REG} is applied to primary circuit controller 71 via an optocoupler 71. As a result, battery voltage V_{B} will increase as shown in FIG. 3 and secondary circuit controller 81 will continue to modulate the amplitude AMP of regulation voltage V_{REG} as needed until regulation voltage V_{REG} reaches a voltage recharge level V_{RL} below maximum voltage threshold V_{MAX}. Upon battery voltage V_{B} reaching voltage recharge level V_{RL}, secondary circuit controller 80 initiates a leveling stage S2 whereby secondary circuit controller 81 modulates the amplitude AMP of regulation voltage V_{REG} as needed to decrease the transformer voltage in a direction toward the battery voltage V_{B} for attenuating battery current I_{B} until the completion of stage S2 as shown in FIG. 4. FIG. 5 illustrates a recharging circuit of the present invention for two (2) rechargeable batteries 20 of any type. This recharging circuit is identical to the recharging circuit of FIG. 1 with the exception of an addition of secondary power switches 21 and a control of switches 21 by secondary circuit controller 80. With these additions, the recharging circuit may operate in a sequential recharging mode or a simultaneous recharging mode.

In an exemplary sequential recharging mode, upon secondary switch controller 80 detecting a presence of rechargeable batteries 20, secondary switch controller 80 will close secondary power switch 21(1) and open secondary power switch 21(2) whereby rechargeable battery 20(1) will be recharged to a fully charged state prior to a recharging of rechargeable battery 20(2), such as, for example, in accordance with FIGS. 3 and 4. Upon rechargeable battery 20(1) being fully charged, secondary switch controller 80 will open secondary power switch 21(1) and close secondary power switch 21(2) whereby rechargeable battery 20(1) will be recharged to a fully charged state, such as, for example, in accordance with FIGS. 3 and 4.

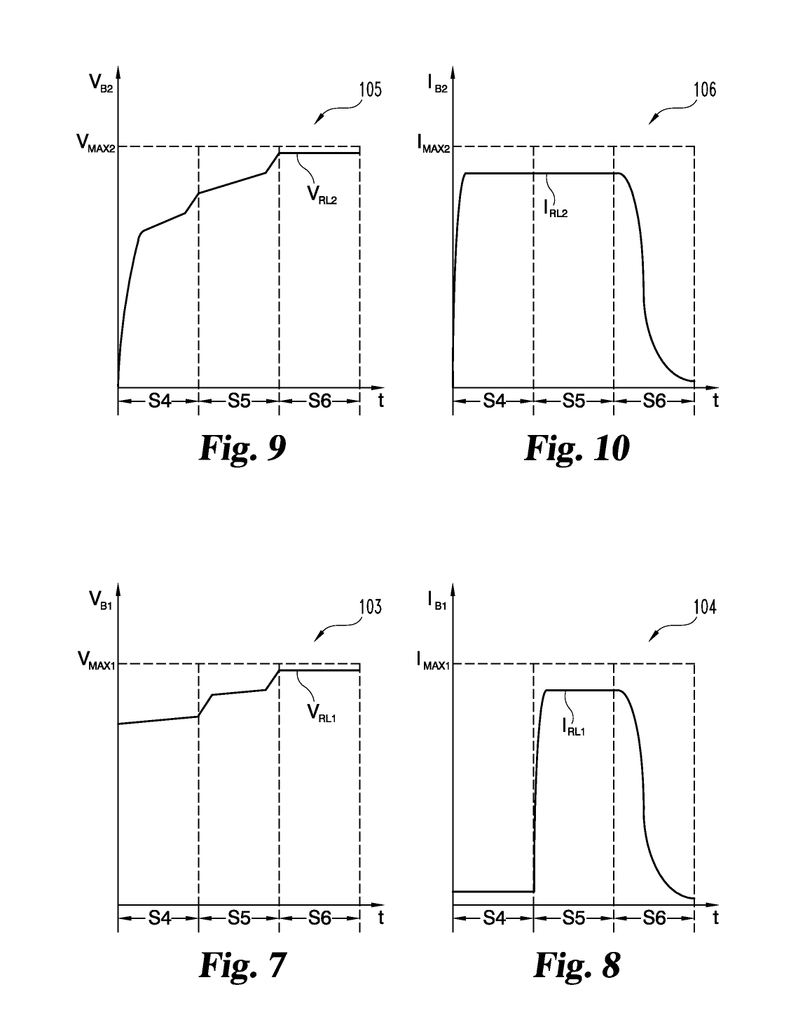

In an exemplary simultaneous recharging mode, secondary circuit controller 80 initiates a solo recharging stage S4 by closing secondary power switch 21(1) and opening secondary power switch 21(2) whereby secondary circuit controller 80 modulates the amplitude AMP of regulation voltage V_{REG} as needed to increase the transformer voltage (not shown) above battery voltage V_{B1} to a degree for immediately increasing battery current I_{B1} to a recharging current level I_{RL1} below maximum current threshold I_{MAX1} as shown in FIG. 8. As a result, battery voltage V_{B1} will increase as shown in FIG. 7 and secondary circuit controller 80 will continue to modulate the amplitude AMP of regulation voltage V_{REG} as needed until battery voltage V_{B1} equals battery voltage V_{B2}. which are below respective maximum voltage thresholds V_{MAX1} and V_{MAX2}.

Upon battery voltage V_{B1} equaling battery voltage V_{B2}, secondary circuit controller 80 initiates a simultaneous recharging stage S5 by keeping secondary power switch 21(1) closed and closing secondary power switch 21(2) whereby secondary circuit controller 80 modulates the amplitude AMP of regulation voltage V_{REG} as needed to increase the transformer voltage (not shown) above battery voltage V_{B1} and battery voltage V_{B2} to a degree for maintaining battery current I_{B2} at the recharging current level I_{RL1} below maximum current threshold I_{MAX1} as shown in FIG. 8 and for increasing battery current I_{B2} to a recharging current level I_{RL2} below maximum current threshold I_{MAX2} as shown in FIG. 10. As a result, battery voltage V_{B1} will increase as shown in FIG. 7 and battery voltage V_{B2} will increase as shown in FIG. 9. Secondary circuit controller 80 will continue to modulate the amplitude AMP of regulation voltage V_{REG} as needed until battery voltages V_{B1} and V_{B2} reach respective recharging voltage levels V_{RL1} and V_{RL2}, which are below respective maximum voltage thresholds V_{MAX1} and V_{MAX2}.

Upon battery voltages V_{B1} and V_{B2} reach respective recharging voltage levels V_{RL1} and _{VRL2,} secondary circuit controller 80 initiates a leveling stage S6 whereby secondary circuit controller 80 modulates the amplitude AMP of regulation voltage V_{REG} as needed to decrease the transformer voltage in a direction toward battery voltages V_{B1} and V_{B2} for attenuating battery currents I_{B1} and I_{B2} until the completion of stage S6 as shown in FIGS. 8 and 10.

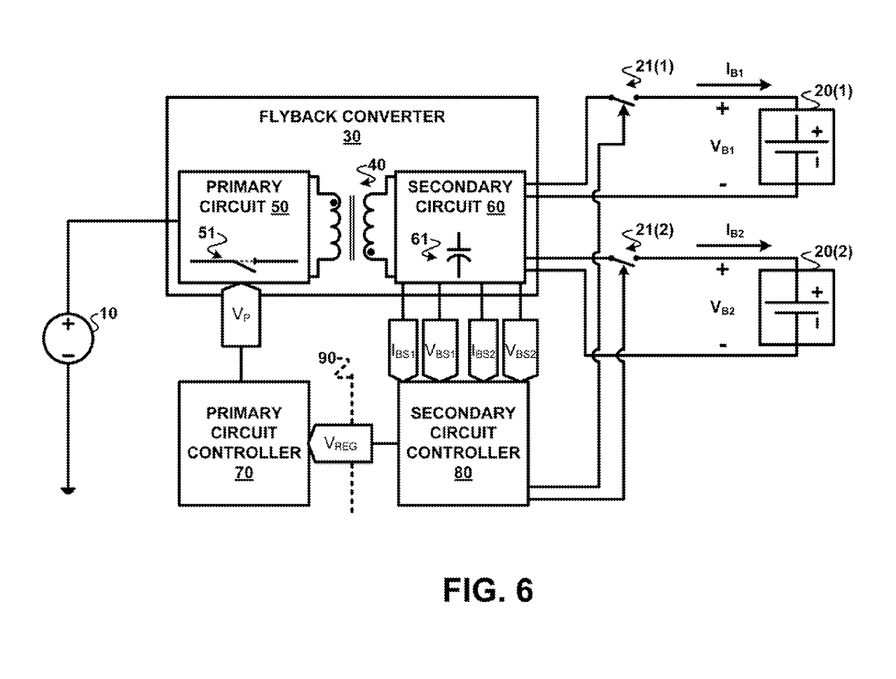

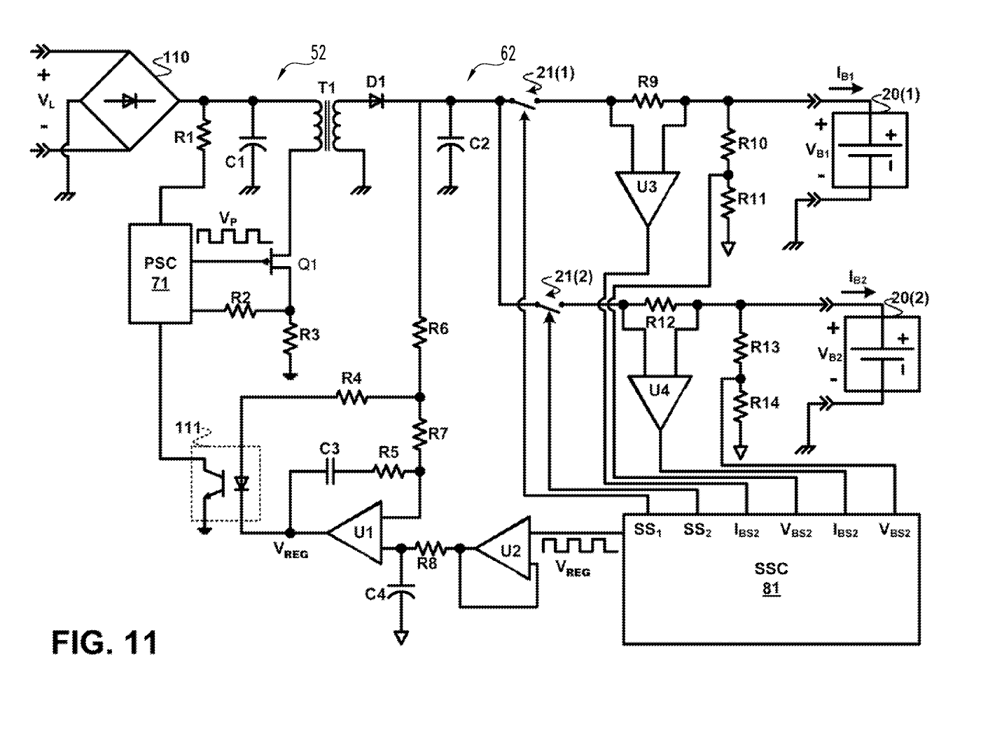

FIG. 11 illustrates a more detailed embodiment of the recharging circuit of FIG. 6. This recharging circuit is identical to the recharging circuit of FIG. 5 with the exception of an addition of secondary power switches 21 and a control of switches 21 by secondary circuit controller 80. Also added are resistors R12-R14 and op-amp U4. Op-amp U4 applies a differential between the transformer voltage and battery voltage V_{B2} across resistor R12 to enable secondary circuit controller 81 to sense battery current I_{B2}. Resistors R13 and R14 operates as a voltage divider to enable secondary circuit controller 81 to sense battery voltage V_{B2}.

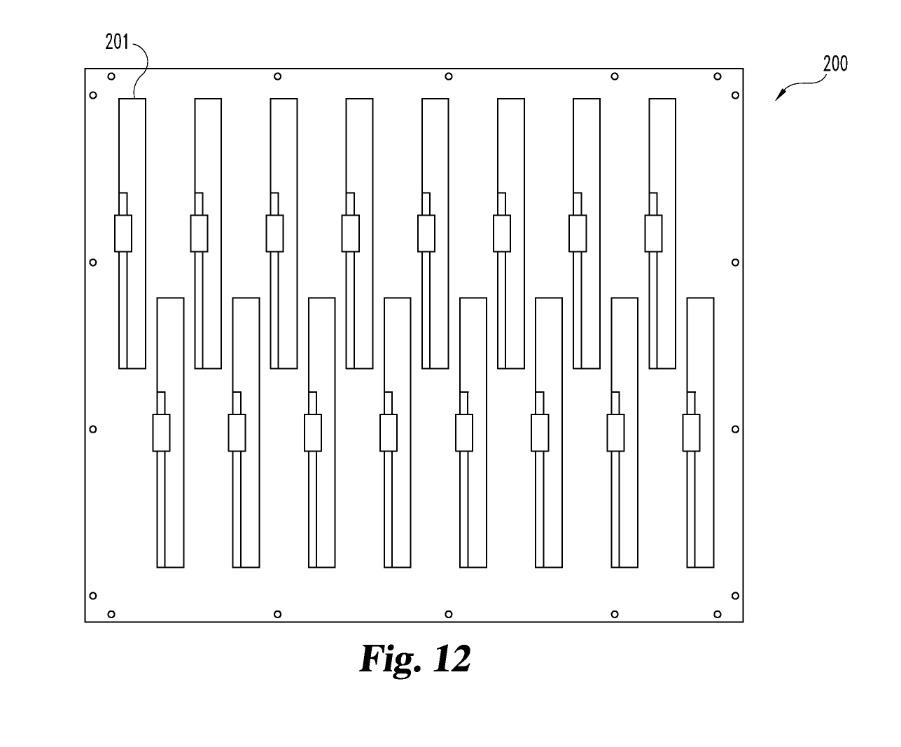

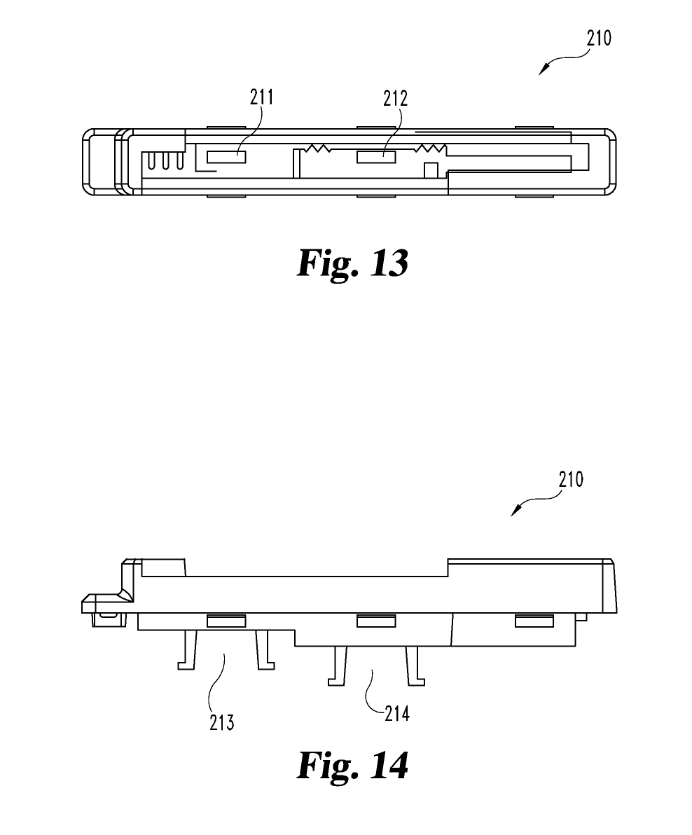

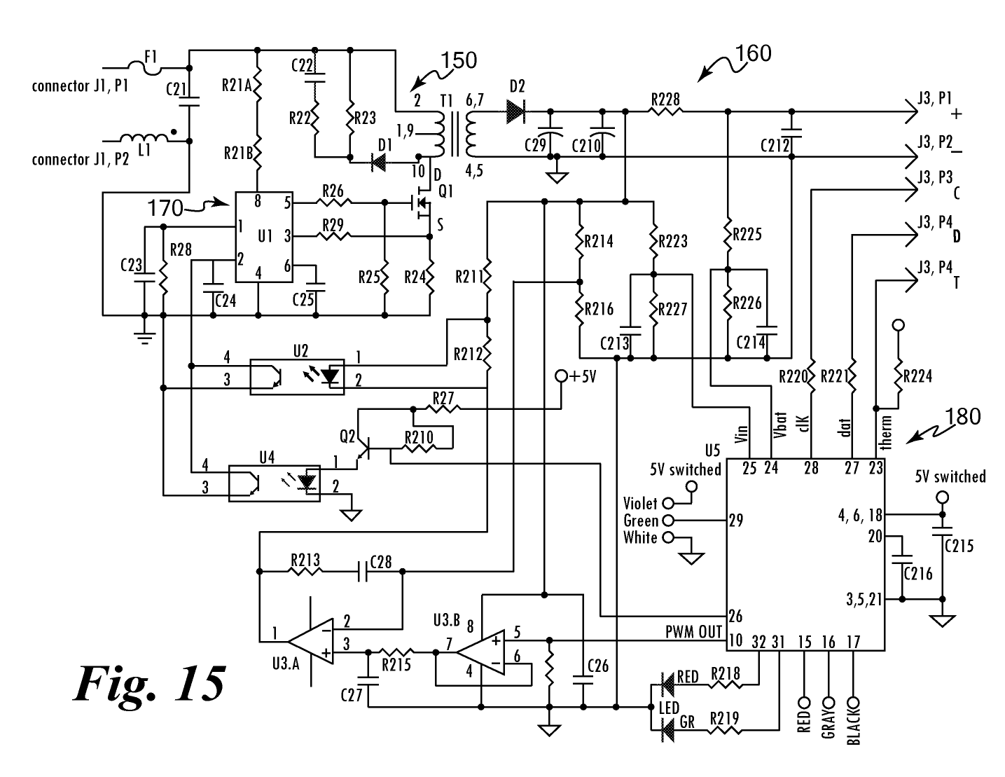

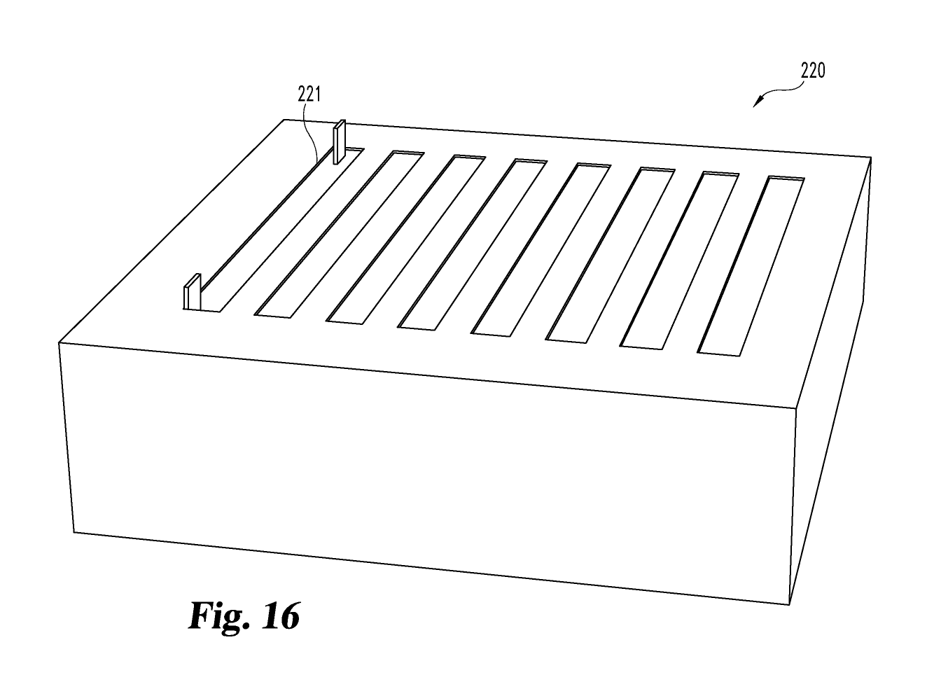

FIG. 12 illustrates a 16-bay rechargeable battery charger 200. In one embodiment, charger 200 employs a vacuum formed charger top with formed pockets 201 that fit a specific single type. In a more preferred embodiment, charger 200 employs injection molded pockets that fit into cut-aways in the metal top whereby the injection molded pockets are designed to fit a multitude of battery types that share a set of physical features (i.e. the footprint), such as, for example, an injection molded pocket 210 shown in FIGS. 13 and 14. Pocket 210 has slots 211 and 212 with respective ports 213 and 214 for supporting an electrical connected on rechargeable batteries to the recharging circuit. Pocket 210 may support a large array of batteries of the same footprint.

A recharging circuit suitable for charger 200 is shown in FIG. 15. This recharging circuit employs a primary circuit 150, a secondary circuit 160, a primary circuit controller 170 and a secondary circuit controller 180. Particularly, the primary circuit controller 170 employs a NCP1216 OWM controller U1 having an ADJ pin 1, a FB pin 2, a CS pin 3, a VSS pin 4, a DRV pin 5, a VCC pin 6 and a HV pin 8. Of importance are FB pin 2 for setting a peak current setpoint as a function of the regulation voltage, CS pin 3 for sensing the primary current and DRV pin 5 for applying the voltage pulses to MOSFET Q1.

Further, secondary circuit controller 180 employs a ATMEL Mega 48 microprocessor. Particularly, the microprocessor has a pin 10 for outputting the pulse width modulated regulation voltage, a pin 25 for sensing the battery current I_{B}, a pin 24 for sensing the battery voltage V_{B} and pins 27 and 28 for communicating with the rechargeable battery to ascertain the maximum voltage and current thresholds of the battery.

FIG. 16 illustrates an 8-bay rechargeable battery charger 220. In one embodiment, charger 220 employs a vacuum formed charger top with formed pockets 221 that fit a specific single type. In a more preferred embodiment, charger 220 employs injection molded pockets that fit into cut-aways in the metal top whereby the injection molded pockets are designed to fit a multitude of battery types that share a set of physical features (i.e. the footprint), such as, for example, an injection molded pocket 210 shown in FIGS. 13 and 14.

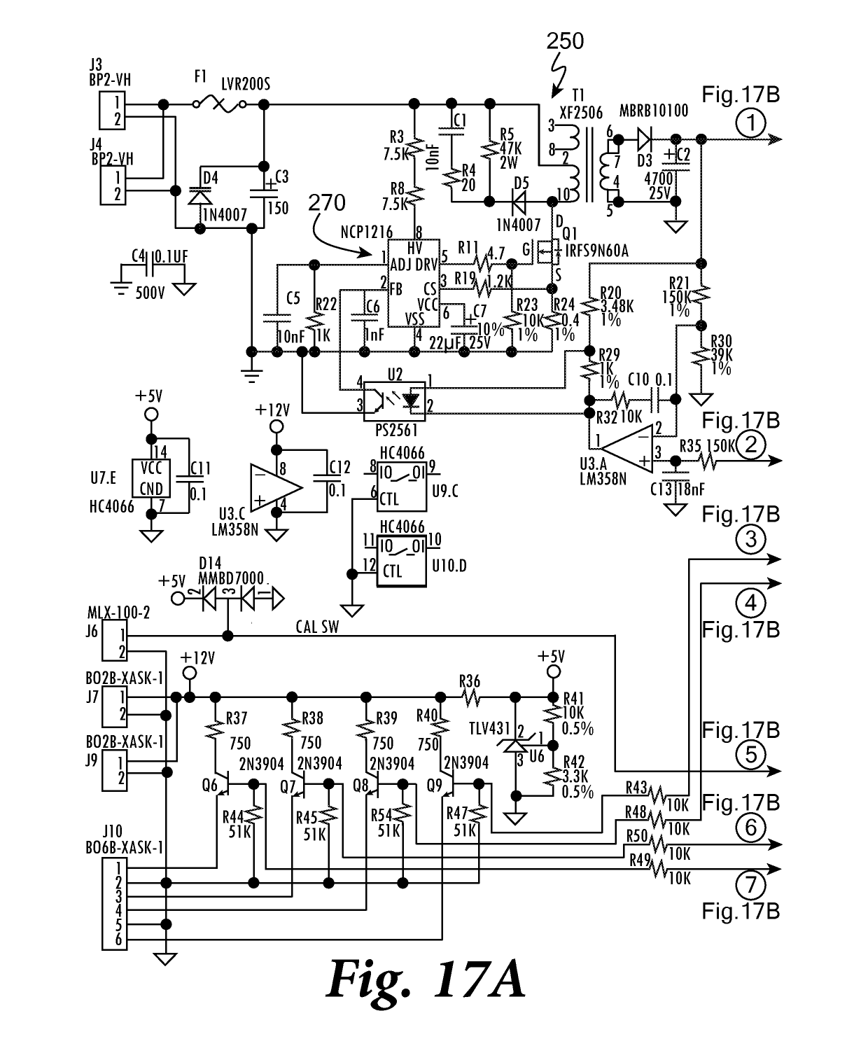

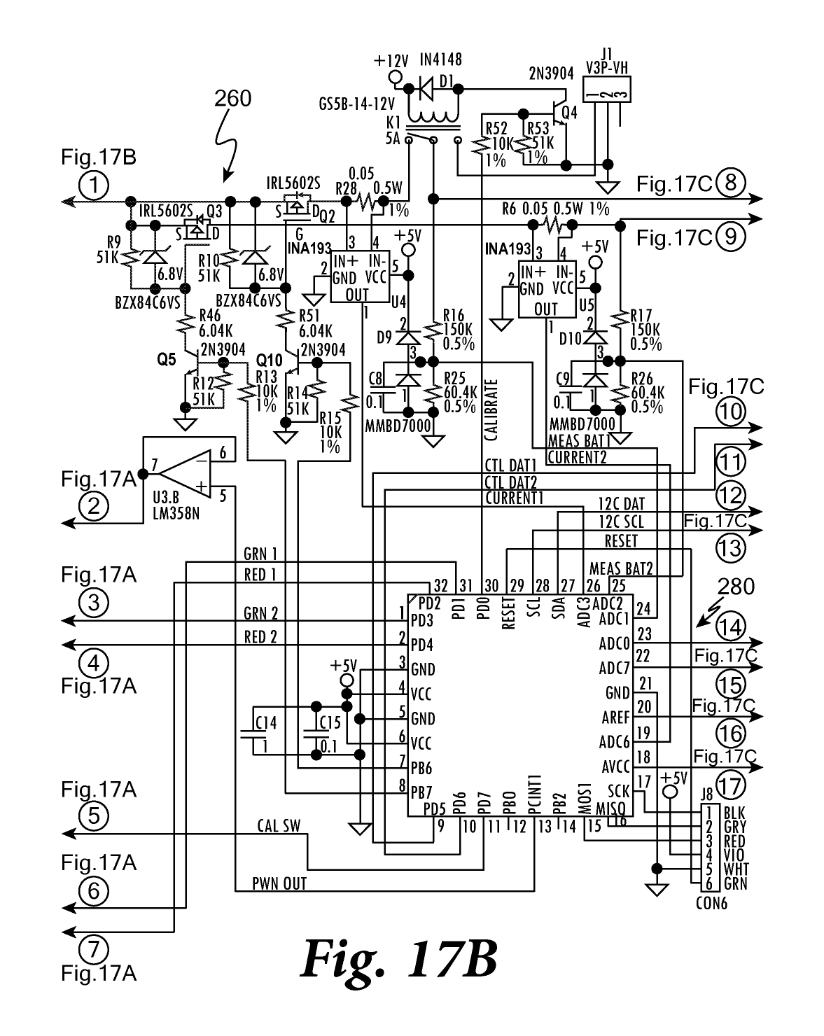

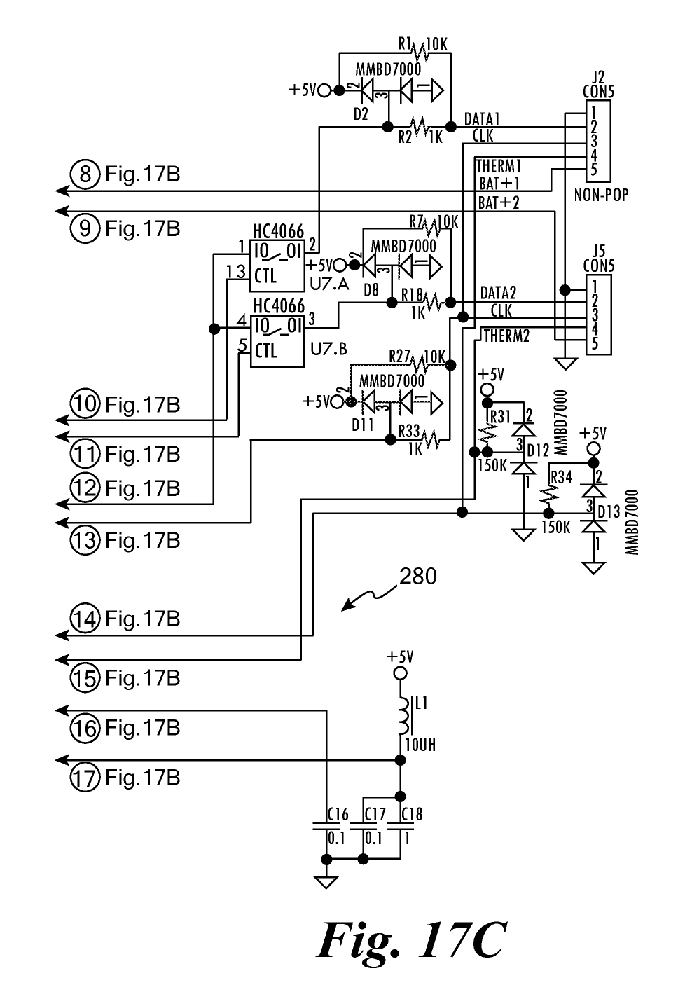

A recharging circuit suitable for charger 220 is shown in FIG. 17. This recharging circuit employs a primary circuit 250, a secondary circuit 260, a primary circuit controller 270 and a secondary circuit controller 280 for operating in a sequential recharging mode or a simultaneous recharging mode. Particularly, the primary circuit controller 170 employs a NCP1216 OWM controller U1 having an ADJ pin 1, a FB pin 2, a CS pin 3, a VSS pin 4, a DRV pin 5, a VCC pin 6 and a HV pin 8. Of importance are FB pin 2 for setting a peak current setpoint as a function of the regulation voltage, CS pin 3 for sensing the primary current and DRV pin 5 for applying the voltage pulses to MOSFET Q1.

Further, secondary circuit controller 180 employs a ATMEL Mega 48 microprocessor. Particularly, the microprocessor has a pin 13 for outputting the pulse width modulated regulation voltage, pins 19 and 26 for sensing the respective battery currents I_{B2} and I_{B1}, pins 24 and 25 for sensing the respective battery voltages V_{B1} and V_{B2}, pins 9 and 10 for communicating with the rechargeable batteries to ascertain the respective maximum voltage and current thresholds of the battery, and pins 7 and 8 for controlling respective secondary power switches Q3 and Q2.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A multi-bay battery charger for recharging a plurality of rechargeable batteries, the multi-bay battery charger comprising:
a power supply;
a flyback converter including a transformer defining a primary circuit and a secondary circuit,
wherein the primary circuit includes a primary control switch having a closed state for electrically connecting the transformer to the power supply and an open state for electrically disconnecting the transformer from the power supply, and
wherein the secondary circuit is operable to be electrically connected to at least one rechargeable battery for supplying a battery voltage and a battery current to each rechargeable battery;
a primary circuit controller in electrical communication with the primary control switch to apply a voltage pulse to the primary control switch for selectively closing the primary control switch; and
a secondary circuit controller in electrical communication with the secondary circuit to electrically sense the battery voltage and the battery current being supplied by the secondary circuit to each rechargeable battery connected to the secondary circuit,
wherein the secondary circuit controller is in further electrical communication with the primary circuit controller to applies a regulation voltage to the primary circuit controller for modulating a duty cycle of the voltage pulses provided by the primary circuit controller to the primary control switch, and
wherein the secondary circuit controller modulates an amplitude of the regulation voltage as a function of the sensed battery voltage of each rechargeable battery relative to a maximum voltage threshold of each rechargeable battery and as a function of the sensed battery current of each rechargeable battery relative to a maximum current threshold of each rechargeable battery.

2. The multi-bay battery charger of claim 1, further comprising:
a rechargeable bay in electrical communication with the secondary circuit to electrically connect the at least one rechargeable battery to the secondary circuit in response to the at least one rechargeable battery being inserted in the rechargeable bay.

3. The multi-bay battery charger of claim 2, wherein the rechargeable bay accommodates at least two dissimilar types of rechargeable batteries having a common set of at least one physical feature.

4. The multi-bay battery charger of claim 1,
wherein the secondary circuit includes a secondary power switch for each rechargeable battery electrically connected to the secondary control switch; and
wherein each secondary control switch has a closed state for electrically connecting the transformer to a respective rechargeable battery and an open state for electrically disconnecting the transformer from the respective rechargeable battery.

5. The multi-bay battery charger of claim 4, wherein the secondary circuit controller is in electrical communication with each secondary power switch for selectively opening and closing each secondary power switch in dependence of an operating mode of the multi-bay battery charger.

6. The multi-bay battery charger of claim 5,
wherein the operating mode is a sequential recharging mode for sequentially recharging each rechargeable battery to a fully charged state; and
wherein only a single secondary power switch is closed at any given time during the sequential recharging mode.

7. The multi-bay battery charger of claim 5,
wherein the operating mode is a simultaneous recharging mode for simultaneously recharging each rechargeable battery to a fully charged state;
wherein only a single secondary power switch is closed in response to a differential in the battery voltages of at least two voltage batteries being greater than a recharging threshold; and
wherein each secondary power switch is closed in response to the differential in the battery voltages of at least two voltage batteries being less than a recharging threshold.

8. A multi-bay battery charger for recharging a first rechargeable battery and a second rechargeable battery, the multi-bay battery charger comprising:
a power supply;
a flyback converter including a transformer defining a primary circuit and a secondary circuit,
wherein the primary circuit includes a primary control switch having a closed state for electrically connecting the transformer to the power supply and an open state for electrically disconnecting the transformer from the power supply,
wherein the secondary circuit is operable to be electrically connected to the first rechargeable battery for supplying a first battery voltage and a first battery current to the first rechargeable battery, and
wherein the secondary circuit is operable to be electrically connected to the second rechargeable battery for supplying a second battery voltage and a second battery current to the first rechargeable battery;
a primary circuit controller in electrical communication with the primary control switch to apply a voltage pulse to the primary control switch for selectively closing the primary control switch; and
a secondary circuit controller in electrical communication with the secondary circuit to electrically sense the first battery voltage, the second battery voltage, the first battery current and the second battery current being supplied by the secondary circuit to each rechargeable battery connected to the secondary circuit,
wherein the secondary circuit controller is in further electrical communication with the primary circuit controller to provide a regulation voltage to the primary circuit controller for modulating a duty cycle of the voltage pulses provided by the primary circuit controller to the primary control switch, and
wherein the secondary circuit controller modulates an amplitude of the regulation voltage as a function of the sensed battery voltage of each rechargeable battery relative to a maximum voltage threshold of each rechargeable battery and as a function of the sensed battery current of each rechargeable battery relative to a maximum current threshold of each rechargeable battery.

9. The multi-bay battery charger of claim 8, further comprising:
a rechargeable bay in electrical communication with the secondary circuit to electrically connect the first rechargeable battery and the second rechargeable battery to the secondary circuit in response to the first rechargeable battery and the second rechargeable battery being simultaneously inserted in the rechargeable bay.

10. The multi-bay battery charger of claim 9, wherein the first rechargeable battery and the second rechargeable battery are dissimilar types having a common set of at least one physical feature.

11. The multi-bay battery charger of claim 8,
wherein the secondary circuit includes a secondary power switch for each rechargeable battery electrically connected to the secondary control switch; and
wherein each secondary control switch has a closed state for electrically connecting the transformer to a respective rechargeable battery and an open state for electrically disconnecting the transformer from the respective rechargeable battery.

12. The multi-bay battery charger of claim 11, wherein the secondary circuit controller is in electrical communication with each secondary power switch for selectively opening and closing each secondary power switch in dependence of an operating mode of the multi-bay battery charger.

13. The multi-bay battery charger of claim 12,
wherein the operating mode is a sequential recharging mode for sequentially recharging each rechargeable battery to a fully charged state; and
wherein only a single secondary power switch is closed at any given time during the sequential recharging mode.

14. The multi-bay battery charger of claim 12,
wherein the operating mode is a simultaneous recharging mode for simultaneously recharging each rechargeable battery to a fully charged state;
wherein only a single secondary power switch is closed in response to a differential in the battery voltages of the rechargeable batteries being greater than a recharging threshold; and
wherein each secondary power switch is closed in response to the differential in the battery voltages of the rechargeable batteries being less than a recharging threshold.
